(19) United States
(12) Patent Application Publication
(10) Pub. No.: US 2025/0128538 A1
(43) Pub. Date: Apr. 24, 2025

(54) METHOD AND APPARATUS FOR CREATING DESIGNS, IMAGES, VIDEOS, PATTERNS, OR ALTERED SURFACES

(71) Applicant: Jeremiah Alley, Los Angeles, CA (US)

(72) Inventor: Jeremiah Alley, Los Angeles, CA (US)

(21) Appl. No.: 18/919,020

(22) Filed: Oct. 17, 2024

Related U.S. Application Data
(60) Provisional application No. 63/591,242, filed on Oct. 18, 2023.

(51) Int. Cl. B43L 11/05; G03B 17/56

(52) U.S. Cl. CPC B43L 11/05; G03B 17/561

(57) ABSTRACT

An apparatus and method for creating designs, images, videos, patterns, or altered surfaces may include a frame having an opening, a rotatable structure having a mount affixation point, a mount affixed at the mount affixation points, a turning mechanism that rotates the rotatable structure, and, e.g., a camera or a mounted on the mount. The rotatable structure can generate at least one of a design, an image, a video, a pattern, or an altered surface. The method may include using such an apparatus to generate a design, an image, a video, a pattern, or an altered surface.

### CROSS-REFERENCE TO RELATED APPLICATIONS

The present application claims priority to U.S. Provisional Patent Application No. 63/591,242, filed Oct. 18, 2023. The entire contents of this application is incorporated herein in its entirety.

### FIELD OF THE INVENTION

The present invention relates to methods and apparatuses for the creation of designs, images, videos, patterns, or altered surfaces (herein, “designs”). In accordance with embodiments of the invention, designs are created using a device comprised of a rotatable structure (herein, a “wheel”) that rotates within a frame. In accordance with embodiments of the invention, a light, laser, camera, tool, or other item may be affixed to the wheel. In accordance with embodiments of the invention, both the wheel and the frame have gear teeth, allowing the wheel to rotate around the frame. In accordance with embodiments of the invention, a camera may be used to capture images of a light, laser, or item as the camera rotates in a curved pattern on the wheel. Unlike conventional spirographs, devices and methods according to the present invention may be used to produce spirographic designs in a greater variety of sizes, media, and orientations.

### BACKGROUND OF THE INVENTION

Devices for producing geometric designs have existed since at least the 1800s. In 1844, Hugh Blackburn, a professor of mathematics at the University of Glasgow in Scotland, created the harmonograph. The harmonograph employed swinging pendulums to control the movement of a pen relative to a drawing surface. By combining two perpendicular harmonic motions, the harmonograph produced designs known as Lissajous curves. Around 1890, the Polish mathematician and engineer Bruno Abakanowicz invented the first spirograph. The spirograph involved turning a gear inside or along the outer perimeter of a larger gear, to produce curves known as hypotrochoids or epitrochoids. A hypotrochoid is a roulette curve traced by a point on the radius of a circle which rotates inside the perimeter of another circle. An epitrochoid is a roulette curve traced by a point on the radius of a circle which rotates outside the perimeter of another circle. Examples of spirographic designs created via computer simulation, including hypotrochoids and epitrochoids, can be seen in FIGS. 6a, 6b, 6c, and 6d.

In 1908, Sears, Roebuck & Co. first debuted “The Marvelous Wondergraph” in its sales catalog. The Marvelous Wondergraph consisted of a pen held in a fixed position above a drawing surface that could be rotated by the user using a pulley system. In 1965, the British engineer Denys Fisher took Abakanowicz's spirograph device and commercialized it for the public. Fisher's spirograph consisted of a set of plastic wheels, rings, and pens. To draw a shape, an user would place a smaller wheel within one of the larger rings. Both the wheels and rings contained gear teeth, allowing the wheel to rotate within the ring. The user would place the wheel and ring on a piece of paper, insert a pen though a hole in the wheel, and then turn the wheel within the ring, while holding the pen against the paper. Fisher licensed his invention to Hasbro, Inc., which continues to produce and sell “The Spirograph” to the present day.

All of these existing devices for producing geometric patterns are limited to paper or similar media, and involve a pen, pencil, marker, or similar writing instrument. In these devices, the writing instrument must make contact with the horizontal drawing surface. Moreover, the wheel or drawing surface is turned by hand or gravity, thus limiting the size and scale of the designs that can be produced. In The Spirograph produced by Hasbro, Inc., the pen is held is by the user. Thus, there exists a need for a device that can produce geometric or other designs in a greater variety of media (e.g., light, woodworking, photography) and of greater variety in size, shape, orientation, and dimension. The present application addresses these, and other, needs in the art.

### BRIEF SUMMARY OF THE INVENTION

In accordance with embodiments of the invention, a device for producing designs, images, videos, patterns, or altered surfaces designs is provided. The apparatus may include a frame having an opening, a rotatable structure having at least one mount affixation point, a mount affixed to the rotatable structure at a mount affixation point, a turning mechanism configured to rotate the rotatable structure, and at least one of a camera, a set of cameras, a light, a set of lights, a scene, an object, a shape or set of shapes, a laser, a set of lasers, a tool, or an apparatus mounted on the mount, wherein the rotatable structure is configured to rotate within the opening and about its own axis, and wherein rotating the rotatable structure within the opening and about its own axis generates at least one of a design, an image, a video, a pattern, or an altered surface.

In accordance with embodiments of the invention, a method for producing designs, images, videos, patterns, or altered surfaces designs is provided. The method may include providing a frame having an opening, providing a rotatable structure having at least one mount affixation point, affixing a mount to the rotatable structure at a mount affixation point, providing a turning mechanism configured to rotate the rotatable structure, mounting at least one of a camera, a set of cameras, a light, a set of lights, a scene, an object, a shape or set of shapes, a laser, a set of lasers, a tool, or an apparatus on the mount, operating the turning mechanism to rotate the rotatable structure, such that the rotatable structure rotates both within the opening and about its own axis, and generating at least one of a design, an image, a video, a pattern, or an altered surface through the rotation of the rotatable structure.

### BRIEF DESCRIPTION OF THE DRAWINGS

Referring now to the drawings, where like numerals represent like features or components:

FIG. 1 is a general exploded view of a device for making designs in accordance with embodiments of the invention, wherein the device is powered by a motor.

FIG. 2 is a general exploded view of a device for making designs in accordance with embodiments of the invention, wherein the device is powered by a hand crank.

FIG. 3 is a general unexploded view of a device for making designs in accordance with embodiments of the invention.

FIG. 4 is a side view of a device for making designs in accordance with embodiments of the invention.

FIG. 5 is a front view of a device for making designs in accordance with embodiments of the invention.

FIGS. 6a, 6b, 6c, and 6d depict spirographic patterns produced using a computer simulation, to demonstrate the principles of the present invention.

FIG. 7 is a top view of a device for making designs in accordance with embodiments of the invention.

FIG. 8 is a rear view of a device for making designs in accordance with embodiments of the invention.

FIG. 9 is a perspective view of a device for making designs in accordance with an embodiment of the invention in which a camera is mounted to the mount.

FIG. 10 is a side view of a device for making designs in accordance with an embodiment of the invention in which a camera is mounted to the mount.

FIG. 11 is a front view of a device for making designs in accordance with an embodiment of the invention in which a camera is mounted to the mount.

### DETAILED DESCRIPTION OF THE INVENTION

The present invention is described by reference to the following embodiments thereof. However, it is to be understood that those of ordinary skill in the art would recognize various modifications and versions of these embodiments. Applicant intends this disclosure to encompass all such modifications and versions that would be apparent to one of ordinary skill.

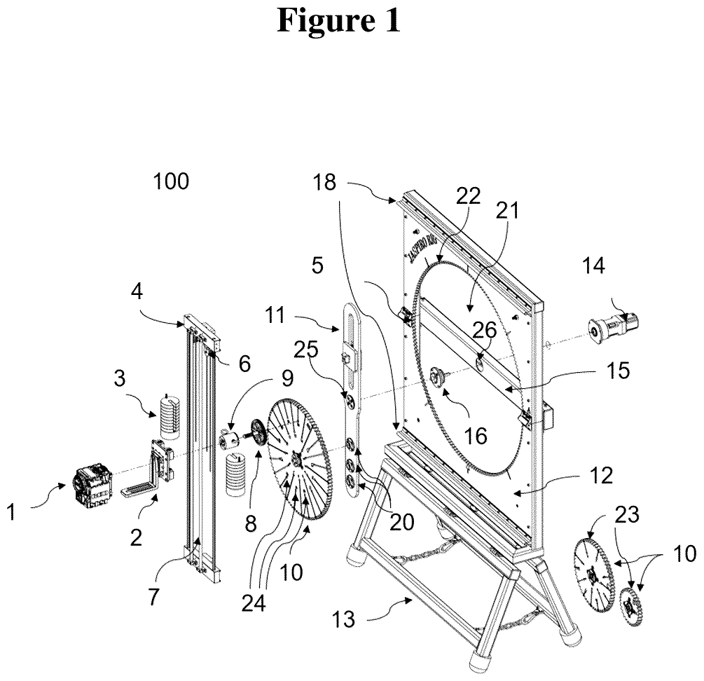

FIG. 1 is a general exploded view of a device 100 made in accordance with embodiments of the invention. As shown in FIG. 1, the device 100 may include a camera 1 attached to a moveable mount 2. Any type of camera that is capable of taking still or video images may be used as the camera 1, such as digital cameras, film-based cameras, etc. In some embodiments, as is shown in FIG. 1, the camera 1 is oriented to face away from the device 100, and towards a light, laser, set of lights, wall, screen, or other object to be photographed (not shown). In other embodiments, the camera 1 may be oriented to face towards the device 100, or it may be oriented to face in any direction. Further, in some embodiments, the camera 1 may be mounted on a moveable ball head, gimbal, or similar device which would permit the camera to rotate along multiple axes (including during use of the device), thus permitting the camera to point in essentially any direction. In some embodiments, the ball head, gimbal, or similar device may be powered and/or operated independently of the device 100.

In some embodiments, the moveable mount 2 is affixed to a platform 4, which allows the mount 2 and camera 1 to be moved to a variety of positions. The platform 4 may include one or more slider rods 7, one or more pulleys 6, and one or more counterweights 3. The mount 2 may be moveably affixed to one or more slider rods 7, which allow the mount 2 to move up and down in the vertical direction. The one or more pulleys 6 and one or more counterweights 3 may apply force to the moveable mount 2, to assist in moving the mount 2 up and down along the one or more slider rods 7.

The device 100 further includes a frame 12. Although, in FIG. 1, the frame 12 is shown as rectangular in shape, persons of skill in the art would know that any suitable shape could be used. The frame 12 includes an opening 21, around whose outer edge are disposed a plurality of frame gear teeth 22. Although, in FIG. 1, the opening 21 is shown as being circular in shape, persons skilled in the art would recognize that the opening 21 may have any of a variety of shapes, including oval, square, rectangular, diamond, or any other polygonal shape.

The device 100 includes one or more removable wheels 10. Along the outer edge of each wheel 10 may be disposed a plurality of wheel gear teeth 23. The wheels 10 may be of any size and shape suitable for producing the desired designs. For instance, in FIG. 1, three different wheels 10 are shown, each being circular in shape, and each having a different radius. However, any number of wheels could be used, and each wheel could be of any suitable shape—including square, rectangular, elliptical, diamond, or any other polygonal shape—and of any suitable size. The shape and size of the wheels 10, as well as the shape and size of the opening 21, affect the shape of the spirographic pattern that will be produced when the device 100 is used.

In some embodiments, each wheel 10 includes a plurality of affixation points 24. The affixation points 24 may comprise holes or openings in the wheel 10, of suitable size and shape to permit a mating engagement with an adjustment knob 8. Each affixation point 24 represents a different point on the wheel to which the mount 2 may be affixed. Mounting the mount 2 at different affixation points 24 changes the design that the device will create.

To facilitate the use of affixation points 24, each affixation point 24 may be labeled with a different number, letter, or other identifying designation. These designations may be used to rapidly and efficiently identify different affixation points 24. Additionally, visual aids, such as radial lines extending from the outer edge of the wheel 10 to each affixation point 24 (as shown in FIG. 1), may be provided on the surface of the wheel 10. These designations and aids may assist the user in creating designs in a repeatable, predictable manner. For example, a user may place a laser, camera, or other item at a designated affixation point 24 on the wheel 10. Selecting different points on the wheel allows the user to produce different spirographic designs. Additional markings may also appear on the frame 12. A user may use the numbered points and markings to, for example, keep track of the degree to which the wheel 10 has rotated around the frame 12.

In some embodiments, to affix the mount 2 to an affixation point 24, the device 100 uses a quick release collar 9 and adjustment knob 8. As seen in FIG. 1, the adjustment knob 8 may include a protrusion with an engagement surface, such as a threaded surface. The quick release collar 9 may include a cavity with a mating engagement surface, which matches the engagement surface of the protrusion of the adjustment knob 8. To affix the mount 2 to the quick release collar 9, the protrusion of the adjustment knob 8 may be inserted into the cavity of the quick release collar 9, and may be further inserted into a matching cavity (with a matching engagement surface) in the mount 2. When the protrusion of the adjustment knob 8 is suitably tightened, or a firm connection is otherwise established, the mount 2 is affixed to the quick release collar 9 and the adjustment knob 8.

Subsequently, to affix the mount 2 to the wheel 10, a user (not shown) selects an affixation point 24 on the wheel. The adjustment knob 8 is placed in contact with the selected affixation point 24, and is then affixed to the selected affixation point 24 by any suitable means. For instance, the adjustment knob may be rotated until it establishes a firm, rigid contact with the surface of the wheel 10 around the affixation point 24, such that the axial pressure from the wheel 10 holds the adjustment knob 8 in place. Alternatively, a second protrusion may extend from the adjustment knob 8 through a hole of the affixation point 24, with suitable fastening means on the reverse side of the wheel 10, to hold that second protrusion in place. Those of skill in the art would know that these are examples only, and that any suitable means of affixing the adjustment knob 8 to the wheel 10 may be used.

In embodiments, the diameter of the circular portion of the adjustment knob 8 may be selected to permit the user to rapidly remove the collar and release the wheel with just one hand, making the other hand available to hold and release the wheel 10.

To affix the wheel 10 to the frame 12, the device 100 may further include a wheel control bar 11 and a frame support bar 15. The frame support bar 15 may be fixedly attached to the frame 12, and may—for instance—span the opening 21 in the horizontal direction, as shown in FIG. 1. The frame support bar 15 includes an opening 26 with an engagement surface that matches the engagement surface of a shaft plate 16. The wheel control bar 11 also includes an opening 25 with an engagement surface that matches an engagement surface of the shaft plate 16. To install the wheel control bar 11 onto the frame support bar 15, the shaft plate 16 is fixedly engaged with the opening 25 of the wheel control bar 11, and is rotatably engaged with the opening 26 of the frame support bar 15. When rotational force is applied to the shaft plate 16, the fixed engagement between the shaft plate 16 and the wheel control bar 11 causes the wheel control bar 11 to rotate.

For affixation of the wheel 10, the wheel control bar 11 includes a plurality of wheel attachment points 20. Each wheel attachment point 20 permits the wheel 10 to be rotatably engaged with the wheel control bar 11. Any suitable fastening means that permits such rotatable engagement may be used, as would be known to those of skill in the art.

The device 100 may further include slider tracks 18 positioned near the top and bottom edges of the frame 12. In operation, the platform 4 may be installed between the slider tracks 18. In some embodiments, the slider tracks 18 are constructed to allow a moveable engagement between the slider tracks 18 and the top and bottom edges of the platform 4. In such embodiments, when the platform 4 is installed between the slider tracks 18, the moveable engagement allows the platform 4 to move in the horizontal direction. Since the slider rods 7 also allow the mount 2 to move in the vertical direction, the combination of the mount 2, platform 4, and slider tracks 18 allow the mounted device (e.g., a camera) to move in both the horizontal and vertical directions, allowing a full two-dimensional range of motion, and thus allowing the device to create a full range of spirographic or other designs or images.

In other embodiments (not shown), additional rods (e.g., follow focus rods used in the film and photography industries) could be attached to the platform 4 and frame 12 to allow the camera 1 and mount 2 to move in the z-axis direction (i.e., closer to and away from the frame 12). This would give the camera a full three-dimensional range of motion, and thus allow the device to create an even greater range of spirographic or other designs or images.

In some embodiments, as shown in FIG. 1, rotational force is supplied to the shaft plate 16 via a motor 14. For instance, a protrusion of the shaft plate 16 may be inserted into a cavity of the motor 14, wherein the cavity of the motor 14 has an engagement surface matching that of the protrusion of the shaft plate 16. When the motor is turned on, it supplies rotational force to the protrusion of the shaft plate 16. That rotational force is transferred to the wheel control bar 11 through the fixed engagement between the wheel control bar 11 and the shaft plate 16 (at opening 25). That causes the wheel control bar 11 to rotate about the axis of the shaft plate 16.

When the wheel 10 is installed at one of the wheel attachment points 20, there is an engagement between the wheel gear teeth 23 and the frame gear teeth 22. As the wheel control bar 11 rotates about the axis of the shaft plate 16, that engagement causes the wheel 10 to separately rotate about its own axis. Accordingly, the device 100 causes at least two simultaneous rotations: the rotation of the wheel control bar (which causes the wheel 10 to rotate around the opening 21), and the rotation of the wheel about its own axis. Both rotations are transferred to the mount 2 and camera 1 via the engagement between the wheel 10, the adjustment knob 8, the quick release collar 9, and the mount 2. Accordingly, the mount 2 and camera 1 undergo two simultaneous rotations, allowing the camera to capture a variety of interesting spirographic designs or images.

As those of skill in the art would recognize, various parameters of the device 100 can be altered to change the spirographic design captured by the camera 1. These include, at least: (i) the shape and size of the opening 21; (ii) the shape and size of the wheels 10; (iii) the spacing of the wheel gear teeth 23 and frame gear teeth 22; (iv) the selection of which affixation point 24 on the wheel 10 the mount 2 is attached to; (v) the selection of which attachment point 20 on the frame control bar 11 the wheel is attached to; (vi) the speed and direction of rotational motion supplied by the motor 14; and many others.

Additionally, the spirographic designs captured by the camera 1 will change depending on what the camera 1 is pointing at. For instance, in a simple case, the camera 1 could be pointed at a single light bulb, or a single LED light of a particular color. That would produce a particular set of spirographic designs. Alternatively, the camera 1 could be pointed at a set of light bulbs, or a set of different LED lights of the same or different colors, each of which could be spaced in an infinite array of different arrangements. Each such arrangement would produce different spirographic designs. In addition to lights, the camera 1 could be pointed at essentially any other scene, object, shape, or set of objects/shapes, to capture an infinite number of unique designs. The only limitation is the creativity of the user, and all such uses are within the scope of the invention.

In the foregoing, the device 100 was described such that a camera 1 is mounted on the rotating wheel 10 and wheel control bar 11, and the scene to be captured is set at a fixed position away from the device, in the direction in which the camera is pointing. However, in other embodiments, this arrangement can be inverted. For instance, in embodiments of the invention, a camera 1 may be arranged in a fixed position, facing the device 100. The scene to be captured—such as a light, a set of lights, a laser, a set of lasers, or any other object, shape, or set of objects or shapes—can be mounted on the mount 2. In operation, the scene to be captured would rotate with both the wheel control bar 11 and the wheel 10, and the camera 1 would capture these rotations to capture unique spirographic designs. All such uses are within the scope of the invention.

Alternatively, two devices 100 could be used simultaneously, facing each other. A camera 1 could be mounted on one device, and the scene to be captured could be mounted on the other. Both devices could then be operated simultaneously, to capture unique designs.

In other embodiments, a laser may be used with the device 100 to create spirographic designs. For instance, a laser could be mounted on the mount 2, and pointed at a wall or screen. For instance, a camera 1 could be pointed at the wall or screen to capture a time-lapse image of the laser dot as it passes across the wall or screen over time in a spirographic shape. Alternatively, the camera 1 could be attached to the mount 2 and rotate with the wheel 10, while capturing an image of a still object, such as a laser or set of lasers. As another alternative, instead of using a wall or screen, the camera could be pointed directly towards the wheel 10 to capture an image of a light or object mounted on the mount 2. Many other alternative arrangements and positions of the camera 1, wheel 10, and laser or object would also be apparent to a person of ordinary skill. All such alternative arrangements are within the scope of the current invention.

In other embodiments, the device 100 may be used to create spirographic designs in a medium not requiring a camera 1. For example, a woodworking tool, marker, knife, paint brush, or other tool could be attached to mount 2, and the device 100 could be positioned immediately adjacent to a surface suitable to be used with the tool (e.g., for a paint brush, a canvas). In these embodiments, the tool or instrument would then produce a design directly on the surface. In the woodworking context, for example, a carpenter could attach a wood router or carving bit to the mount 2, and position a wood piece next to the device 100 so that the router or bit carves a spirographic design into the wood piece. The use of other additional design tools and instruments would also be apparent to a person of ordinary skill (e.g., paintbrush, marker, pen, pencil, charcoal, blow torch, welding gun, paint gun, engraver, knife, powered knife, chainsaw, etching tool, etc.). All such alternative arrangements are within the scope of the current invention.

The wheel 10, frame 12, and other components of the device 100 may be made from any suitable material, such as metal, wood, plastic, etc. The wheel 10 may have gear teeth on its outer edge, allowing it to interlock with the gear teeth of the frame 12. By varying the number of gear teeth on the wheel 10 and frame 12, the user can produce different spirographic designs. In addition, multiple wheels and cameras/scenes could be affixed to the device at the same time to create “layers” of simultaneous spirographic designs or images.

As would be apparent to a person of ordinary skill, in the motorized embodiment, the motor 14 could be integrated with a computer so that the speed and power of the motor 14 could be programmed and controlled. The computer could be configured to communicate with a user's wireless device (e.g., smartphone, tablet, laptop) via software on the computer and the user device. Various spirographic designs and configurations of the device 100 could be saved and stored on the computer and the user device, and used to create different designs. For instance, a user could program the computer to cause the motor to execute a pre-set pattern of rotations at particular speeds, directions, and durations. Each such pattern would create a different spirographic image. Alternatively, a user could program the computer to cause the motor to execute a partially- or fully-randomized pattern of rotations. A user could also program the computer to cause the motor to start or stop at particular times, for instance, to capture time-lapse images at pre-defined (or randomized) times. All such uses are within the scope of the invention.

In some embodiments, the frame 12 is attached to a stand 13. The attachment between the frame 12 and the stand 13 may be by any suitable mechanism that provides the requisite support and stability. In some embodiments, the attachment mechanism also makes it easy for a user to remove the frame 12 from the stand 13. When the device 100 is to be disassembled, the frame 12 may be detached from the stand 13, and the frame 12 may be folded in half using hinges 5. This foldable design allows the user to easily transport the device 100 to different locations.

In embodiments, the hinges 5 are custom-designed hinges made to securely hold the weight of the frame while permitting a quick release method, allowing rapid disassembly of the device.

The size of the device 100 could be varied based on the artistic medium to be used and the level of portability needed. Although, in FIG. 1, stand 13 is shown as supporting the device 100 in a vertical position, alternative positions could be obtained through the use of different stands 13, such as horizontal or angled positions. In alternative embodiments, depending on the size and shape of the device 100, a stand may not even be needed. For instance, instead of mounting it on the stand 13, in some embodiments, the device 100 could be mounted on one or more tripods or mini-tripods; attached to one or more grips, such as camera grips; attached to one or more pipe clamps; hung from suitable hanging means (ropes, chains, etc.) connected to the top and/or bottom of the device 100; or mounted or placed on a wall or table. Still further, a “miniature” version of the device could be constructed for use with GoPros, action cameras, cellular phones, and the like, and such versions also may not require use of the stand 13. Such “miniature” versions may be particularly suited to use with tripods, mini-tripods, grips, or pipe clamps as discussed above.

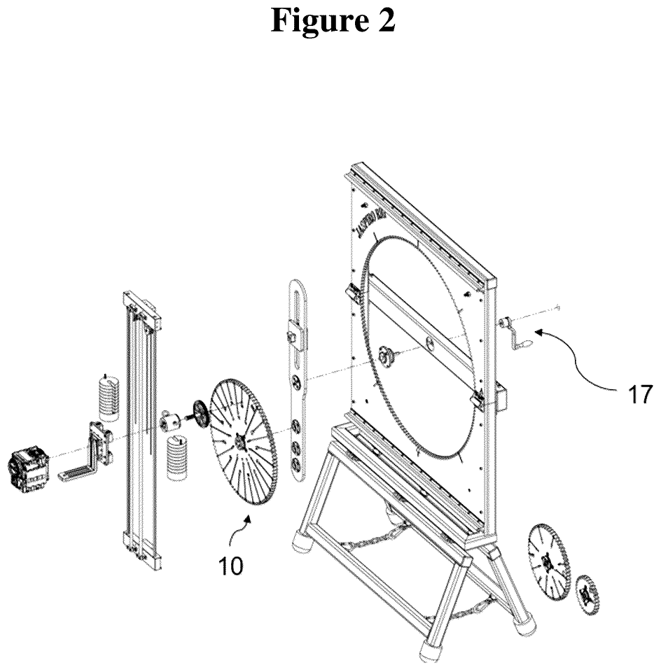

FIG. 2 is a general, exploded view of an embodiment of the device 100 which uses a hand crank 17, rather than a motor 14, to supply rotational force to the wheel control bar 11. In this embodiment, the user uses the crank 17, instead of motor 14, to rotate the wheel control bar 11. In all other respects, the operation of this embodiment is the same as discussed above.

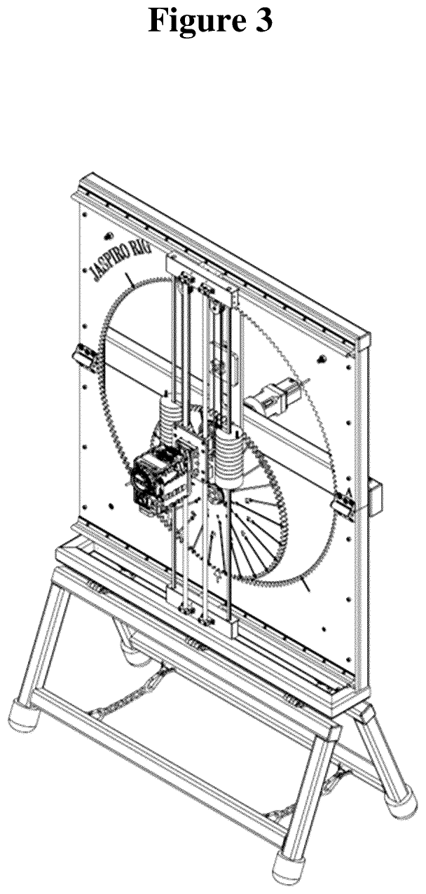

FIG. 3 is a general, un-exploded view of a device 100 made in accordance with embodiments of the invention. In this embodiment, the motor 14 is used instead of crank 17.

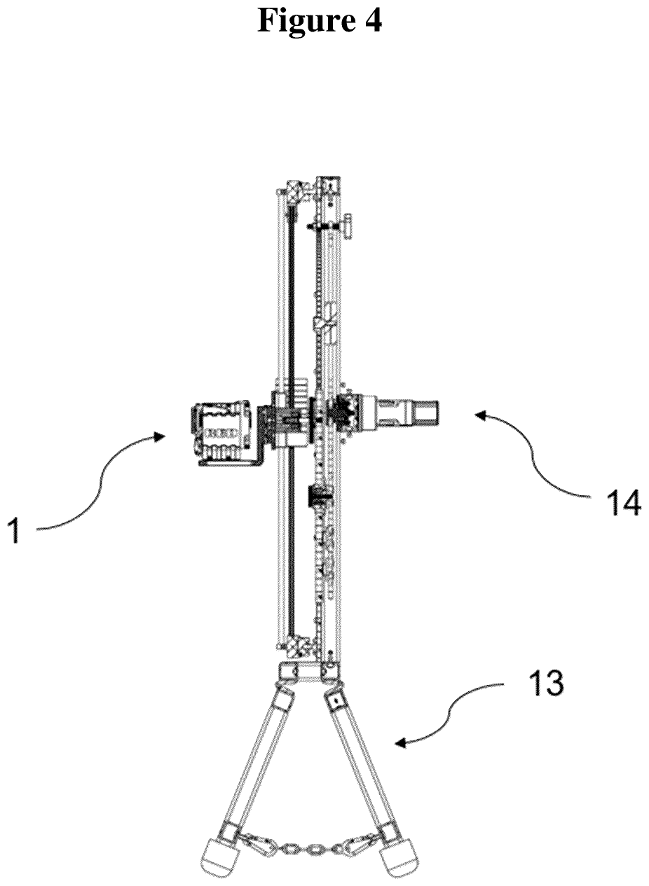

FIG. 4 is a side view of a device made in accordance with embodiments of the invention. In this embodiment, the motor 14 is used instead of crank 17.

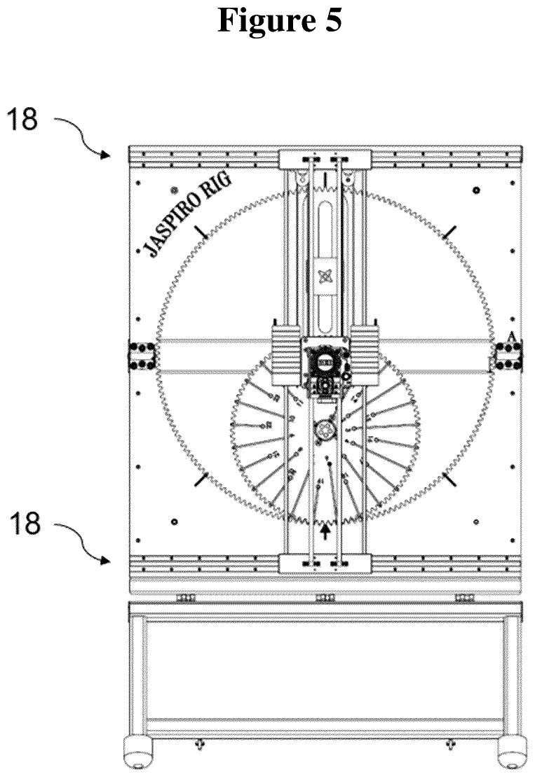

FIG. 5 is a front view of a device made in accordance with embodiments of the invention. In this embodiment, the horizontal slider tracks 18 are clearly visible. Slider tracks 18 are located at the top and bottom of the frame 12, allowing the camera platform 4 to move horizontally.

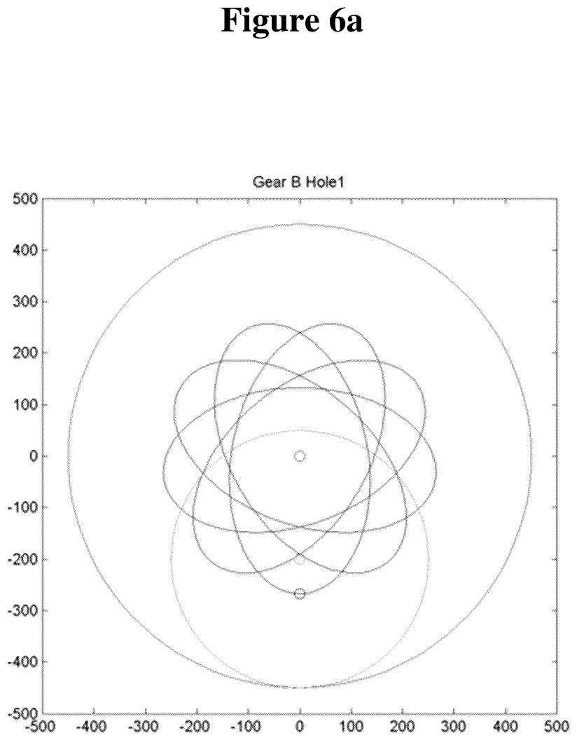

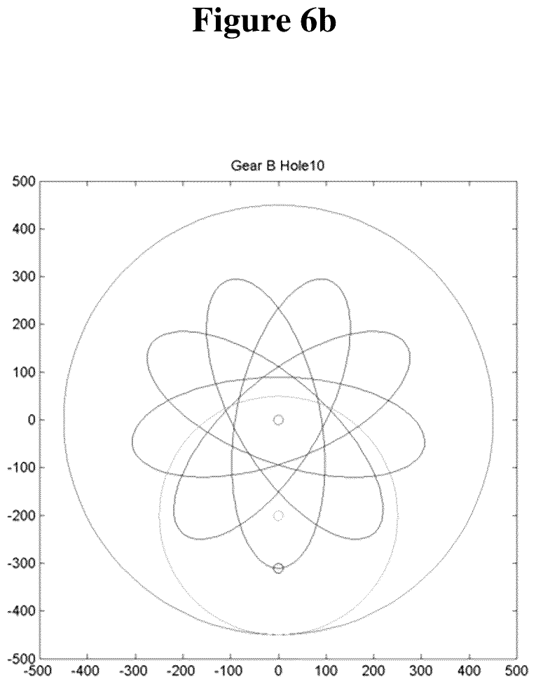

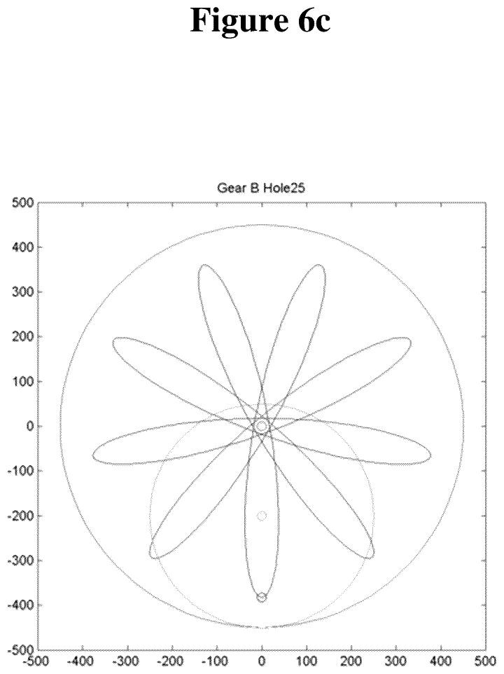

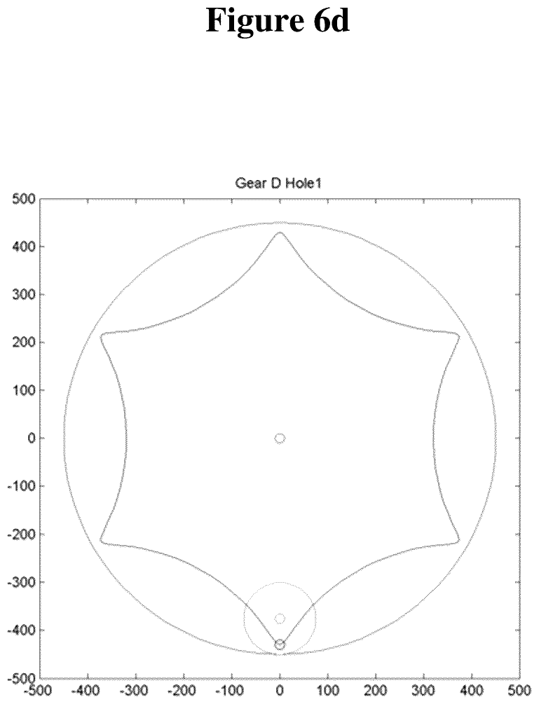

FIGS. 6a, 6b, 6c, and 6d are spirographic designs produced using a computer simulation, in order to demonstrate the types of designs that can be generated with the device 100. In each of these simulation images, the smaller circle was rotated around the larger circle. Thus, the smaller circle represents the wheel 10, while the larger circle represents the opening 21. The lowest dot in each Figure represents the affixation point 24 on the wheel 10 at which the mount 2 is positioned. In the simulation software, a spirographic design was produced by recording the position of that dot over time as the smaller circle rotated around the large circle. The spirographic curves correspond to the path that the mount 2 would take as the device 100 is operated. As can be seen from these images, changing such variables as the size of the wheel 10 (smaller circle), the affixation point 24 of the mount 2 (bottom dot), and others, can dramatically change the path taken by the mount 2, and thus can dramatically change the image that will be captured.

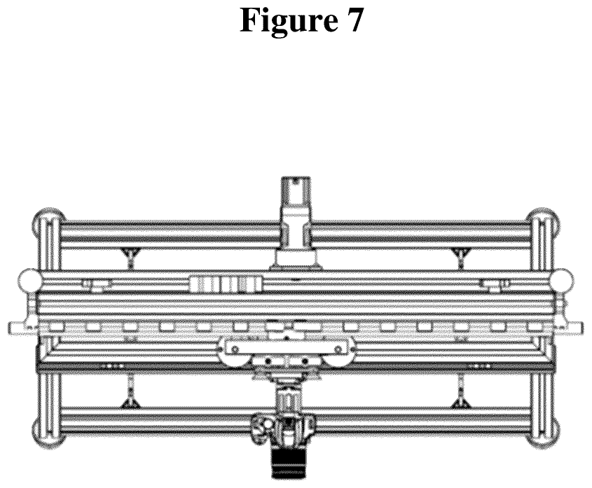

FIG. 7 is a top view of a device for making spirographic designs in accordance with embodiments of the invention.

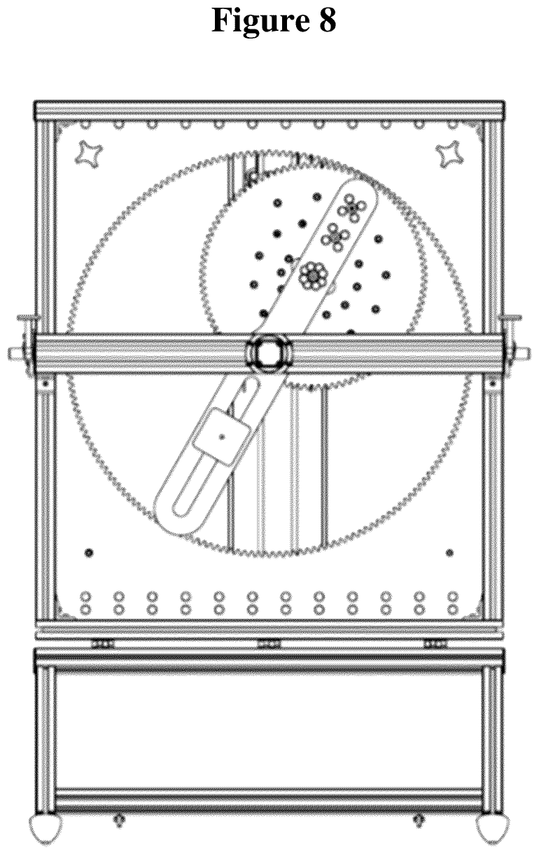

FIG. 8 is a rear view of a device for making spirographic designs in accordance with embodiments of the invention.

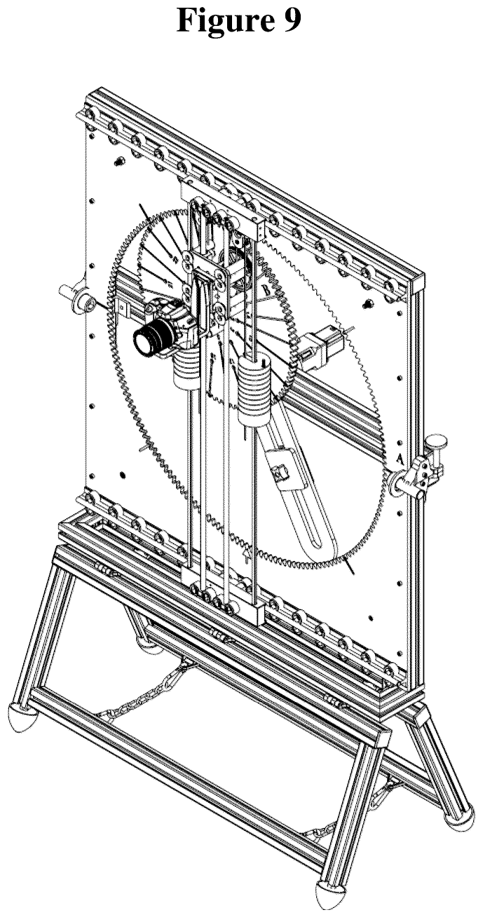

FIG. 9 is a perspective view of a device for making designs in accordance with an embodiment of the invention in which a camera is mounted to the mount.

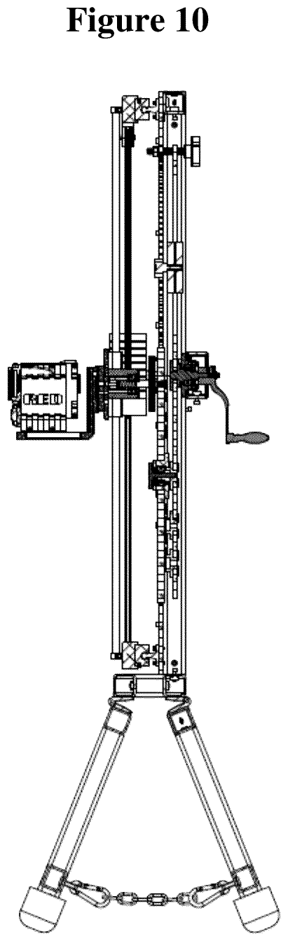

FIG. 10 is a side view of a device for making designs in accordance with an embodiment of the invention in which a camera is mounted to the mount.

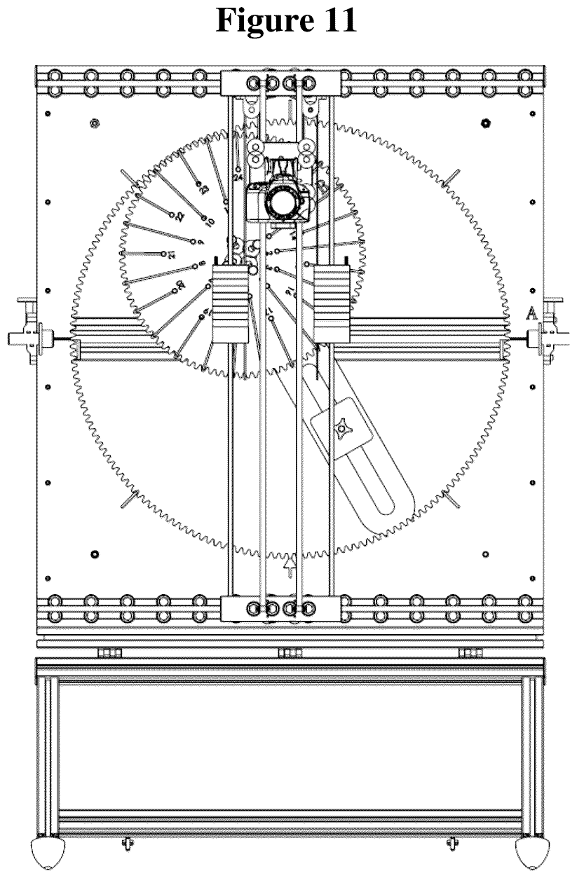

FIG. 11 is a front view of a device for making designs in accordance with an embodiment of the invention in which a camera is mounted to the mount.

The device of the present invention may be adapted to be used in a variety of environments to create a variety of different types of images, designs, videos, and the like. The device may be used in indoor environments, such as a user's studio, film studio, or any other indoor environment. It may also be used in outdoor environments, such as cityscapes, natural environments, or any other outdoor environment. For instance, the device may be used to take images (still or video) of an entire street of city lights at nighttime; of stars in the night sky; or of any other conceivable scene or environment, whether indoors or outdoors. The device may also be programmed to start or stop at pre-defined or randomized times, for instance, in order to take time-lapse images. This gives great depth and versatility to the potential use cases of the invention.

The device of the present invention may also be configured to perform repetitive movements, whether controlling a light or controlling a scene or apparatus affixed to the mount 2, and thus create interesting, varied designs through repetitive motion.

As discussed above, a ball head, gimbal, or other turning mechanism may be provided on the mount 2, thus allowing the camera 1 (or scene, apparatus, etc.) to rotate on the mount during use, and thus adding yet another layer of complexity to the images, designs or videos created.

While, in the foregoing, the invention has been described by reference to certain specific embodiments, those of ordinary skill in the art would recognize a variety of different variations, modifications, and alterations of the described embodiments. All such variations, modifications, and alterations that would be apparent to those of skill in the art are within the scope hereof.

What is claimed is:

1. An apparatus for creating designs, images, videos, patterns, or altered surfaces, comprising:
a frame having an opening;
a rotatable structure having at least one mount affixation point;
a mount affixed to the rotatable structure at at least one of the mount affixation points;
a turning mechanism configured to rotate the rotatable structure; and
at least one of a camera, a set of cameras, a light, a set of lights, a scene, an object, a shape, a set of objects, a set of shapes, a laser, a set of lasers, a tool, or an apparatus mounted on the mount;
wherein the rotatable structure is configured to rotate within the opening and about its own axis to generate at least one of a design, an image, a video, a pattern, or an altered surface.

2. The apparatus of claim 1, in which the opening has a plurality of gear teeth configured to mate with a plurality of gear teeth on the outer edge of the rotatable structure.

3. The apparatus of claim 1, further comprising a stand configured to support the frame.

4. The apparatus of claim 1, in which the turning mechanism comprises a motor.

5. The apparatus of claim 1, in which the turning mechanism comprises a hand crank.

6. The apparatus of claim 2, further comprising a platform to which the mount is movably affixed.

7. The apparatus of claim 6, further comprising:
at least one counterweight;
at least one pulley; and
at least one slider rod;
in which the at least one counterweight, the at least one pulley, and the at least one slider rod are configured permit the mount to move along the platform in a first direction.

8. The apparatus of claim 7, further comprising:
at least one slider track;
in which the platform is movably affixed to at least one of the at least one slider tracks to permit movement of the platform in a second direction.

9. The apparatus of claim 1, further comprising a gimbal, ball head, gyroscope, or other rotating structure affixed to the mount, and configured to permit the camera, set of cameras, light, set of lights, scene, object, set of objects, shape, set of shapes, laser, set of lasers, tool, or apparatus to rotate.

10. The apparatus of claim 1, further comprising:
a support bar fixedly engaged with the frame; and
a control bar rotatably engaged with the support bar;
in which the rotatable structure is rotatably engaged with the support bar.

11. The apparatus of claim 1, in which a tool or apparatus is mounted on the mount, and in which the tool or apparatus comprises at least one of a paintbrush, a marker, a pen, a pencil, a charcoal, a drawing apparatus, a writing apparatus, a blow torch, a welding gun, a paint gun, an engraver, a woodworking tool, a knife, a powered knife, a chainsaw, or an etching tool.

12. A method of creating designs, images, videos, patterns, or altered surfaces, comprising:
providing a frame having an opening;
providing a rotatable structure having at least one mount affixation point;
affixing a mount to the rotatable structure at at least one of the mount affixation points;
providing a turning mechanism configured to rotate the rotatable structure;
mounting at least one of a camera, a set of cameras, a light, a set of lights, a scene, an object, a set of objects, a shape, a set of shapes, a laser, a set of lasers, a tool, or an apparatus on the mount;
operating the turning mechanism to rotate the rotatable structure, such that the rotatable structure rotates both within the opening and about its own axis; and
generating at least one of a design, an image, a video, a pattern, or an altered surface through the rotation of the rotatable structure.

13. The method of claim 12, in which a tool or apparatus is mounted on the mount, and in which the tool or apparatus comprises at least one of a paintbrush, a marker, a pen, a pencil, a charcoal, a drawing apparatus, a writing apparatus, a blow torch, a welding gun, a paint gun, an engraver, a woodworking tool, a knife, a powered knife, a chainsaw, or an etching tool.

14. The method of claim 13, further comprising:
providing a surface adjacent to the tool or apparatus; and
engaging the tool or apparatus with the surface such that operating the turning mechanism causes the tool or apparatus to alter the surface.
